(19) United States
(12) Patent Application Publication
(10) Pub. No.: US 2025/0126643 A1
(43) Pub. Date: Apr. 17, 2025

(54) MITIGATING INTERFERENCE BETWEEN RADIO DEVICES

(71) Applicant: Nordic Semiconductor ASA, Trondheim (NO)

(72) Inventor: Arne NETTUM, Trondheim (NO)

(73) Assignee: Nordic Semiconductor ASA, Trondheim (NO)

(21) Appl. No.: 18/912,191

(22) Filed: Oct. 10, 2024

(30) Foreign Application Priority Data
Oct. 11, 2023 (GB) 2315560.9

(51) Int. Cl. H04W 74/0808; H04W 28/26

(52) U.S. Cl. CPC H04W 74/0808; H04W 28/26

(57) ABSTRACT

A first radio device is configured, for each of a plurality of further radio devices, to determine a respective connection interval and a respective periodic series of connection events, having a period equal to the connection interval, each connection event comprising time for transmitting data packets to the further radio device. The first radio device communicates the respective connection interval to each of the further radio devices. Before transmitting a first data packet of a connection event, over a radio channel, to a further radio device, the first radio device performs a clear channel assessment to determine whether the radio channel is clear, and, in response, before a start of the connection event, transmits a channel reservation signal over the radio channel until the start of the connection event. It then transmits the first data packet over the radio channel to the further radio device.

### CROSS REFERENCE TO RELATED APPLICATION

This application claims priority from Great Britain Application No. 2315560.9, filed Oct. 11, 2023, which application is incorporated herein by reference in its entirety.

### TECHNICAL FIELD

This invention relates to radio devices and methods of radio communication between radio devices.

### BACKGROUND

Radio spectrum is typically divided into licensed and unlicensed bands by national authorities. Unlicensed bands, such as 2.4 GHz, 5 GHZ and 6 GHz, are available for any radio device to use and are therefore vulnerable to interference between different radio devices that are communicating in the same channel or in nearby channels. Interference can occur between radio devices implementing the same protocol, e.g. between WiFi™ devices, and between radio devices implementing different protocols, e.g. between a WiFi™ device and a Bluetooth™ Low Energy (BLE) device.

Such radio interference, rather than separation distance or signal strength, is often the dominant cause of packet loss in radio communication within unlicensed spectrum.

In order to improve the co-existence of potentially interfering radio devices, some radio protocols support a listen-before-talk (LBT) principle, whereby a device that is about to transmit over a channel first performs a clear channel assessment (CCA) to check that the channel is clear before it starts transmitting. If the channel is busy, it defers its transmission for a time. A CCA may use energy detection (ED) to detect radio energy irrespective of its source and/or may use signal detection (SD) to detect radio signals of a known type or radio protocol.

WiFi™ implements this LBT principle as carrier-sense multiple-access with collision avoidance (CSMA/CA), in which transmission of a packet is delayed by a random time if the medium is identified as busy, and is then transmitted in its entirety. If a timely acknowledgement (ACK) is not received from the intended recipient device, re-transmission is attempted after an exponential backoff period.

Other radio protocols use scheduling to limit interference between devices implementing the same protocol. In BLE, for example, a central device can maintain respective connections to a plurality of peripheral devices, but transmits over at most one connection at a time. The central device can assign each connection a series of regular connection events which provide opportunities for radio packets to be sent from, and optionally received by, the central device. These connection events start at regularly-spaced anchor points that are separated by a connection interval that is assigned to the respective connection. The duration of a connection event can vary depending on how much data is queued for transmission over the respective connection.

This scheduling approach can allow peripheral devices—which may often be battery-powered—to reduce power consumption by deactivating their radio receivers between connection events, and to active them momentarily before each anchor point and to deactivate them shortly after each anchor point (e.g. 16 us after) if no transmission from the central device is detected.

However, a coexistence problem can arise when radio devices implementing LBT are sharing spectrum with radio devices using a scheduling approach. If an LBT-based device is already transmitting when a time slot opens for a scheduling-based device, the scheduling-based device will start transmitting as well, leading to interference.

A scheduling-based device cannot mitigate this by naïvely introducing LBT because, in a busy environment, LBT would result in a high proportion of the scheduled transmission windows being unused, leaving the device unable to gain sufficient channel access to operate properly. Changing the scheduling to increase the number of transmission opportunities is also undesirable as it would require peripheral devices (which may be battery-powered) to keep their radio receivers active more of the time which would increase power consumption.

Embodiments of the present invention seek to provide an improved approach to mitigating interference between radio devices.

### SUMMARY OF THE INVENTION

From a first aspect, the invention provides a first radio device configured:
for each of a plurality of further radio devices, to determine a respective connection interval and a respective periodic series of connection events, having a period equal to the connection interval, each connection event comprising time for transmitting one or more data packets to the further radio device and optionally for receiving one or more data packets from the further radio device;
to communicate the respective connection interval to each of the further radio devices; and
before transmitting a first data packet of a connection event, over a radio channel, to a further radio device of the plurality of further radio devices, to perform a clear channel assessment to determine whether the radio channel is clear, and, in response to determining that the radio channel is clear before a start of the connection event, to transmit a channel reservation signal over the radio channel until the start of the connection event and then to transmit the first data packet over the radio channel to the further radio device.

From a second aspect, the invention provides a radio system comprising a first radio device and a plurality of further radio devices, wherein the first radio device is configured:
for each of the plurality of further radio devices, to determine a respective connection interval and a respective periodic series of connection events, having a period equal to the connection interval, each connection event comprising time for transmitting one or more data packets to the further radio device and optionally for receiving one or more data packets from the further radio device;
to communicate the respective connection interval to each of the further radio devices; and
before transmitting a first data packet of a connection event, over a radio channel, to a further radio device of the plurality of further radio devices, to perform a clear channel assessment to determine whether the radio channel is clear, and, in response to determining that the radio channel is clear before a start of the connection event, to transmit a channel reservation signal over the radio channel until the start of the connection event and then to transmit the first data packet over the radio channel to the further radio device.

From a third aspect, the invention provides a method of radio communication performed by a first radio device, the method comprising:
for each of a plurality of further radio devices, determining a respective connection interval and a respective periodic series of connection events, having a period equal to the connection interval, each connection event comprising time for transmitting one or more data packets to the further radio device and optionally for receiving one or more data packets from the further radio device;
communicating the respective connection interval to each of the further radio devices; and
before transmitting a first data packet of a connection event, over a radio channel, to a further radio device of the plurality of further radio devices, performing a clear channel assessment to determine whether the radio channel is clear, and, in response to determining that the radio channel is clear before a start of the connection event, transmitting a channel reservation signal over the radio channel until the start of the connection event and then transmitting the first data packet over the radio channel to the further radio device.

From a fourth aspect, the invention provides computer software comprising instructions which, when executed by a processor of a first radio device, cause the first radio device to perform a method of radio communication comprising:
for each of a plurality of further radio devices, determining a respective connection interval and a respective periodic series of connection events, having a period equal to the connection interval, each connection event comprising time for transmitting one or more data packets to the further radio device and for receiving one or more data packets from the further radio device;
communicating the respective connection interval to each of the further radio devices; and
before transmitting a first data packet of a connection event, over a radio channel, to a further radio device of the plurality of further radio devices, performing a clear channel assessment to determine whether the radio channel is clear, and, in response to determining that the radio channel is clear before a start of the connection event, transmitting a channel reservation signal over the radio channel until the start of the connection event and then transmitting the first data packet over the radio channel to the further radio device.

Thus it will be seen that, in accordance with embodiments of the invention, the first radio device, after performing a clear channel assessment (CCA), transmits a channel reservation signal to reserve the radio channel until the next scheduled time for exchanging one or more data packets with another radio device. The transmission of a channel reservation signal can help prevent any other nearby radio device, that also implements CCAs, from starting to transmit on the radio channel until the first radio device has concluded its scheduled transmission.

The channel reservation signal may signal to one or more other radio devices that the radio channel is busy (i.e. that it is not clear). These other radio devices may implement a same radio protocol as the first radio device, or they may implement a different radio protocol that supports clear channel assessments (i.e. that implements a listen-before-talk policy).

The first radio device may be configured, in response to determining that the radio channel is clear before the start of the connection event, to wait a random delay time after first detecting that the radio channel is clear before starting to transmit the channel reservation signal. It may be configured to determine whether the radio channel is still clear at the end of the random delay time, and to start transmitting the channel reservation signal if the radio channel is determined still to be clear. The first radio device may generate the random delay time afresh for each connection event. This can help prevent interference if multiple devices are performing CCA for the same channel. The first radio device may be configured to determine whether a receive window for the further radio device remains open, and not to start transmitting the first data packet if the receive window has closed.

The channel reservation signal may take any form. In some embodiments it may be an unmodulated carrier (i.e. a pure sine wave). In other embodiments it may comprise or consist of modulated data. The data may be modulated according to a same modulation scheme as data of the first data packet. However, the modulated data of the channel reservation signal may be static data or random data, rather than variable data such as message data. Every channel reservation signal transmitted by the first radio device may be alike, e.g. containing the same predetermined modulated data. In other embodiments the modulated data may be random data (e.g. comprising one or more pseudo-random values generated by the first radio device).

In some embodiments the channel reservation signal comprises or consists of modulated data having low autocorrelation (e.g. random data, such as a PRBS9 pseudo-random binary sequence). The channel reservation signal may have no header or no cyclic preamble. These features can reduce the risk of a nearby radio device that is configured to detect radio packets by detecting a repeated preamble sequence from incorrectly detecting the channel reservation signal as a wanted radio packet. In some embodiments, the modulated data may comprise one or more low autocorrelation binary sequences (LABS)—i.e. a binary sequence of predetermined length that minimizes the quadratic sum of the autocorrelation function for sequences of that length.

In some embodiments, the first radio device, and each further radio device, is configured for radio communication according to a current or future version of the Bluetooth™ Low Energy (BLE) specification. In particular, the first radio device may be configured to communicate with the further radio devices in accordance with the BLE specification. The first radio device may, in some embodiments, be configured to transmit and optionally receive data packets in each connection event in a 6 GHz band. It may be configured to do so in accordance with a future version of the BLE specification, or in accordance with an extension to a current or older version of the BLE specification. However, the principles disclosed herein are not limited to use with BLE and may be applied to any proprietary or standardised radio protocol that supports periodic times for exchanging one or more data packets (irrespective of whether these are referred to as “connection events” or not).

The clear channel assessment may comprise determining whether a level of radio energy on the radio channel (or on a portion of spectrum that includes the radio channel) is above a noise-floor threshold. The first radio device may be configured to determine the radio channel to be clear if the energy level is below the threshold, and to be busy (i.e. not clear) if the energy level is above the threshold.

The first radio device may be configured, in response to determining that the radio channel is not clear (i.e. is busy), not to transmit the channel reservation signal, at least until and unless the radio channel is determined to be clear before the start of the connection event.

The first radio device may be configured to determine a respective receive window for each further radio device (e.g. through a negotiation with the further radio device), wherein the receive window determines a maximum time that the further radio device will listen for a first data packet of a connection event without receiving the first data packet. The first radio device may be configured to receive a requested receive window duration and/or maximum receive window duration from each further radio device. The first radio device may determine and communicate a respective receive window duration to each further radio device. The further radio device may be configured to activate at least a portion of its receiver circuitry at or before (e.g. shortly before) a start of the receive window, and to deactivate the portion in response to an end of the receive window if it has not started to receive the first data packet within the receive window. This enables each further radio device to set or negotiate a limit on how long its receiver will be active, without receiving a data packet, where the limit can be compatible with power consumption and/or performance requirements of the further radio device.

The first radio device may perform the clear channel assessment ongoingly (e.g. continually or periodically). It may do so at least until a sooner of i) the radio channel being determined to be clear and ii) the start of the connection event. In some embodiments, it may continue the clear channel assessment into the connection event if the channel has not become clear before the start of the connection event. In such embodiments it may perform the clear channel assessment ongoingly until a sooner of i) the radio channel being determined to be clear and ii) an end of a receive window for the further radio device (i.e. until the end of the connection event, if the channel never becomes clear).

The first radio device may be configured to transmit the first data packet over the radio channel to the further radio device in response to determining that the radio channel becomes clear after the start of the connection event and before an end of a receive window for the further radio device. The first radio device may be configured to determine whether the receive window for the further radio device remains open, and not to start transmitting the first data packet if the receive window has closed.

Enabling the first radio device to continue to perform CCA after the start of the connection event, and providing the further radio device with a significant receive window after the connection event starts, allows the system to delay transmission of the first data packet until beyond the start of the connection event, when the channel is busy, and still potentially manage to communicate the packet successfully. This can therefore improve throughput, compared with having to abandon the connection event, by reducing the number of missed connections,

This improvement can scale with the size of the receive window (albeit at the cost of increased power consumption by the further radio devices when channels are busy). Thus, in some embodiments, the first radio device determines, for each further radio device, respective receive windows that extend beyond the starts of respective connection events by more than 16 us, e.g. by at least 32 us, 64 us, 128 us, 1 ms or more. These minimum durations are in addition to any allowance that might be provided before the connection events, e.g. to allow for clock drift.

The first radio device may be configured, in response to determining that the radio channel becomes clear after the start of the connection event, to wait a random delay time after first detecting that the radio channel is clear before starting to transmit the first data packet. It may be configured to determine whether the radio channel is still clear at the end of the random delay time, and to start transmitting the first data packet if the radio channel is determined still to be clear.

The first radio device may be configured to include a time stamp in the first data packet of the connection event, indicative of a time of transmission of the first data packet. It may include a time stamp in the respective first data packet of each connection event. Each further radio device may be configured to use the time stamp of a received first data packet when synchronizing a clock of the further radio device. They may do so instead of synchronizing on the time of receipt of the first data packet. In this way, the further radio devices can compensate for any delay between the start of the connection event and the transmission of the first data packet, resulting from the clear channel assessment.

The first radio device may be configured, for each connection event of each periodic series of connection events, before transmitting a first data packet of the respective connection event, over a respective radio channel, to the respective further radio device, to perform a clear channel assessment to determine whether the radio channel is clear, and, in response to determining that the radio channel is clear, transmitting a channel reservation signal over the radio channel until a start of the connection event and then transmitting the respective first data packet over the radio channel to the further radio device.

The first radio device may be configured to perform the clear channel assessment when communicating in a first band (e.g. a 6 GHz band) and not to perform any clear channel assessment when communicating in a second band (e.g. a 2.4 GHz band). Alternatively, in some embodiments, the first radio device may be configured to perform CCAs and to transmit channel reservation signals when communicating in each of two disjoint frequency bands—e.g. 2.4 GHz and 6 GHz.

In some embodiments, the first radio device may always be configured to receive at least one packet (e.g. comprising an acknowledgement) in a connection event with a further radio device. However, in other embodiments, a further radio device need not always transmit a data packet to the first radio device. For instance, if the first data packet is a broadcast packet, the further radio devices might not transmit any acknowledgement packet in response. Thus, not every connection event need provide time for the first radio device to receive one or more data packets from a respective further radio device.

The first radio device may be configured to transmit a second channel reservation signal, on the radio channel that the first data packet was transmitted on, after (e.g. immediately after) transmitting the first data packet—e.g. starting as soon as transmission of the first data packet has ended. This may help avoid another radio device starting to transmit on the radio channel before the further radio device has transmitted an acknowledgement data packet to the first radio device in response to the first data packet. It may transmit the second channel reservation signal for a predetermined duration, which may be determined to be less than a predetermined interframe spacing (e.g. 150 μs).

The further radio device may be configured to perform a clear channel assessment before transmitting an acknowledgement data packet to the first radio device in response to the first data packet. It may perform the clear channel assessment as a single check (i.e. not ongoingly over time). It may start transmitting the acknowledgement data packet in response to determining that the channel is clear. If the channel is detected as busy, it may not transmit any acknowledgement. The further radio device may determine once a predetermined interframe spacing has elapsed after receiving the first data packet, and may perform the clear channel assessment in response to this determination.

The first radio device may be configured to negotiate a respective quality-of-service (QoS) level with each further radio device. This may be a level from a predetermined set or sequence of levels. The first radio device may be configured to use the respective quality-of-service level for a further radio device to determine how long in advance of a connection event, for the further radio device, to start performing a clear channel assessment. In this way, the QoS level may control the maximum time that a channel reservation signal can be transmitted by the first radio device.

The first radio device may be configured to use the respective quality-of-service level for a further radio device to determine a criterion for increasing an amount of time in advance of each connection event that it starts performing a clear channel assessment. The criterion may specify a minimum level of channel access, dependent on the QoS level, and this time may be increased when a level of channel access falls below the minimum level due to clear channel assessments detecting busy channels. More generally, the first radio device may be configured to increase how long in advance of each connection event, for a further radio device, the first radio device starts performing a clear channel assessment in response to detecting a reduced level of channel access.

The first radio device and each further radio device may be configured to use an adaptive frequency hopping (AFH) process to determine, for each connection event, a respective radio channel over which to transmit one or more data packets of the connection event. The first radio device may be configured to exclude a radio channel from use at least partly in dependence on a result of one or more clear channel assessments performed by the first radio device for the radio channel. In this way, radio channels that have frequent CCA “busy” detections may be excluded from the channel map. This criterion may be applied in addition to one or more other reliability criteria for determining whether to use or exclude a radio channel.

The first radio device may be configured to operate as a central device to the plurality of further devices which may be configured to operate as respective peripheral devices. The first radio device may also be configured to operate, at the same time or at a different time, as a peripheral device to one or more other central devices.

The radio device may be any electrical device, such as a wireless sensor, audio appliance, laptop computer, etc., or it may be a component for use within a larger appliance. In some embodiments it is an integrated circuit, such as a system-on-chip (SoC) or a radio-on-a-chip. It may include an antenna or may comprise an interface for connection to an external antenna. It may comprise interfaces for connection to other external components that may be required for the device to operate, such as a power supply, or a power amplifier, or a crystal oscillator, etc.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain embodiments of the invention will now be described, by way of example only, with reference to the accompanying drawings, in which:

FIG. 1 is a schematic diagram of two potentially-interfering radio systems;

FIG. 2 is schematic diagram of a radio device embodying the invention;

FIG. 3 is a timing diagram of radio communication between two radio devices embodying the invention;

FIG. 4 is a timing diagram of radio communication between the two radio devices, including an ACK packet; and

FIG. 5 is a timing diagram of radio communication between the two radio devices in a busy channel.

### DETAILED DESCRIPTION OF EMBODIMENTS

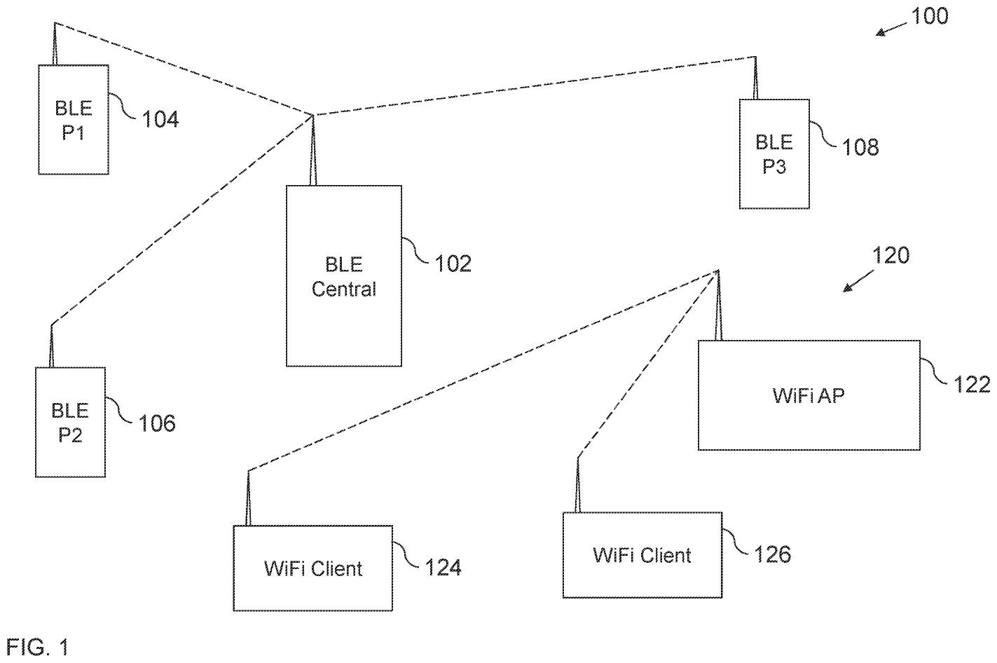

FIG. 1 shows a first radio system 100 that supports Bluetooth™ Low Energy (BLE) communication, and a second radio system 120 that supports WiFi™ communication. The two systems 100, 120 in this example are in radio range of each other. The first and second radio systems thus have the potential to interfere with each other when operating in a common unlicensed radio band.

The first radio system 100 in this example comprises a central device 102 and three peripheral devices P1 104, P2 106 and P3 108 that can exchange data with the central device 102 over respective data connections. Each device 102-108 may be a static or mobile electronic device such as a wireless sensor, a domestic appliance, a vehicle, a personal computer, a cellular telephone, etc. Each device 102-108 may include a processor and memory storing software instructions for execution by the processor. Each may include a radio transceiver, e.g. provided as a radio-on-a-chip, and an antenna, and other components for radio transmission and reception. Any of the operations disclosed herein may be implemented in hardware (e.g. by dedicated analog and/or digital circuitry) or in software, or in any appropriate combination of hardware and software.

The central device 102 can transmit or receive over only one of connection at a time, and is responsible for coordinating access to the radio medium. It does so in a time- multiplexed manner by periodically polling each of the peripheral devices 104-108. The central device 102 assigns each connection to a peripheral device 104-108 a respective connection interval, which is the rate at which a series of regular connection events occurs for the connection.

Each connection event provides an opportunity for the central device 102 to transmit data to the respective peripheral device 104-108, and optionally receive data from the respective peripheral device 104-108. The peripheral device 104-108 will activate its radio receiver for a receive window (RxWindow) at the start of each connection event, to detect any incoming data packet from the central device 102. The RxWindow has a nominal minimum duration of just 16 us so as to limit power consumption by the peripheral devices 104-108 when no data is received.

Multiple packets may be transferred to and from a peripheral device 104-108 by the central device 102 during a single connection event. The central device 102 normally transmits at least one packet in each connection event. However, the central device 102 may on occasions fail to transmit in a particular connection event, e.g. due to scheduling conflicts, or if a subrating factor is being used. It is also possible for the peripheral device 104-108 not to receive a transmitted packet, e.g. due to interference or being out of range. The amount of data that can be exchanged with a peripheral 104-108 during a connection event can vary, but, when the central device 102 is connected to multiple peripherals 104-108, it is constrained by the timing of the next connection event for any of the peripherals 104-108. The start of each connection event is referred to as an anchor point. A long connection interval (e.g. 4 seconds) can lead to lower power consumption for the peripheral, but at the sacrifice of reduced data throughput and higher latency compared with a shorter connection interval.

The first system 100 implements adaptive frequency hopping (AFH). At the start of each connection event, a frequency hop can occur, with a radio channel being deterministically selected from a set of available channels using a channel selection algorithm. The central device 102 monitors packet loss on each of the radio channels and uses this information to maintain and update a channel map that classifies each channel as used (i.e. good) or unused (i.e. bad), depending on whether the channel is sufficiently reliable. In some embodiments, the central device 102 may additionally use CCA results to update the channel map, as described in more detail below. The channel map is shared with the peripheral devices 104-108 so that the devices 102-108 known which channels to use and which to avoid.

The WiFi™ system 120 in this example comprises an access point (AP) 122 and two clients 124, 126. The WiFi™ system 120 does not use regular time-slot scheduling to manage exchanges between its devices but instead implements a listen-before-talk (LBT) policy whereby each device 122-126 uses a carrier sense multiple access (CSMA) approach to perform clear channel assessments (CCA), and only transmits on a particular radio channel when that channel is determined to be clear (i.e. having below a threshold level of noise, and not used or reserved by another WiFi™ device).

Each system 100, 120 may support any current or future version of their respective protocols. They may also support one or more further radio communication mechanisms that are not in a current version of the respective standard. In particular, the first radio system 100 in this example supports the exchange of radio packets in the 6 GHz band, as well as in the 2.4 GHz band, and the WiFi™ radio system 120 in this example also supports the exchange of radio packets in the 6 GHz band. Support for communication in this bands may be implemented in the present first system 100 as an extension to a current or old version of the BLE specification, or in accordance with a proposed or future version of the BLE specification (e.g. a version supporting higher bands).

A problem can arise when devices of two radio systems such as BLE and WiFi™ are in radio range of each other and operating in the same band. Without an appropriate mechanism to mitigate the problem, if a WiFi™ device is already transmitting on a particular channel when a BLE connection event starts for a BLE connection, the BLE central device will begin transmitting on the same channel, leading to interference and potential packet loss for one or both systems. A naïve incorporation of LBT into BLE communications can result in too few opportunities for the BLE devices to communicate in a busy environment, e.g. with unscheduled WiFi™ signals dominating the medium. Increasing the RxWindow of the peripheral devices may improve the likelihood of channel access in such a scenario, since it enables the central device to wait longer for the channel to become clear, but it comes at the expense of a very substantial increase in power consumption by the peripheral devices in order to be effective, which goes against a core principle of BLE which is to enable very low power consumption by requiring peripherals to wake only for a very short time.

Instead, systems disclosed herein mitigate this interference problem through the novel use of clear channel assessments and channel reservation signals, alongside connection events, as described in more detail below with reference to the exemplary first radio system 100.

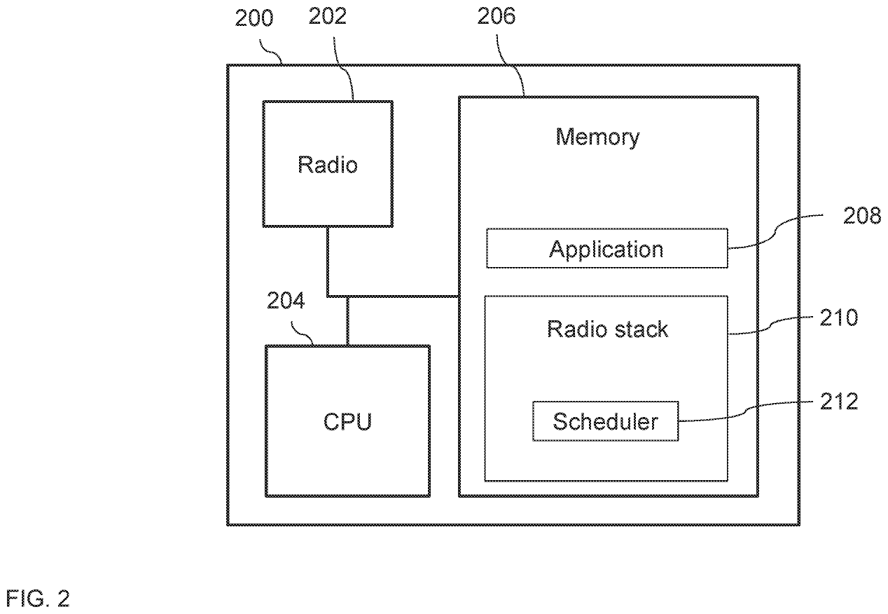

FIG. 2 shows some of the internal components of an exemplary radio device 200 of the first radio system 100. The central device 102 and/or peripheral devices 104-108 may implement such a design. The radio device 200 may be a complete device, such as a wireless sensor, cellular phone, etc., including a power supply, or it may be a component, such as a system-on-chip, e.g. for integration into a more complex device. It includes a radio transceiver 202 which is controlled by a central processing unit (CPU) 204 that executes software stored in a memory 206. The memory 206 may store software, data, parameters, etc. In the present example, the memory 206 stores a software application 208 that makes use of the radio 202 to communicate with one or more of the other devices of the system 100. The application 208 can send and receive data over a radio connection via calls to firmware that implement a radio stack 210.

If the radio device 200 is a central device, the firmware includes within it a scheduler component 212 that can receive transmission tasks from a higher level within the radio stack 210 (e.g. from a host layer) in response to the communication requirements of the application 208. The application 208 and/or peripheral devices 104-108 may have requirements for throughput and/or latency that differ between the peripheral connections and/or that may change over time. These requirements are communicated to the radio stack 210 where they are used to control the connection scheduling and listen-before-talk behaviour, as described below, in order to provide a desired quality of service (QoS).

In order to coexist well alongside other radio systems, such as the WiFi™ system 120, while gaining a fair level of access to shared radio resources (e.g. to channels in the 6 GHz band), the devices 102-108 of the first system 100 are configured to implement LBT, and the central device 102 is additionally configured to transmit channel reservation (CR) signals. The use of LBT prevents devices of the first system 100 from interfering with transmissions by the WiFi™ system 120 that are already underway, while the use of CR signals allows the central device 102 to prevent nearby WiFi™ devices 122-126 from unfairly blocking access to radio channels at the starts of connection events that the central device 102 requires in order to meet the first system's QoS requirements.

Each device 200 of the first system 100 may implement these in its radio stack 210 using software that executes on the CPU 204 or another processor of the device 200.

Before each connection event, the central device 102 performs a listen-before-talk (LBT) clear channel assessment (CCA) for the radio channel it intends to transmit on during the connection event. The CCA may use energy detection to determine if the channel is clear or busy. (The frequency of the radio channel is determined using the

AFH process and current channel map.) The central device 102 starts the CCA at a predetermined time before the start of the connection event, referred to herein as the CCA window (CCAWindow).

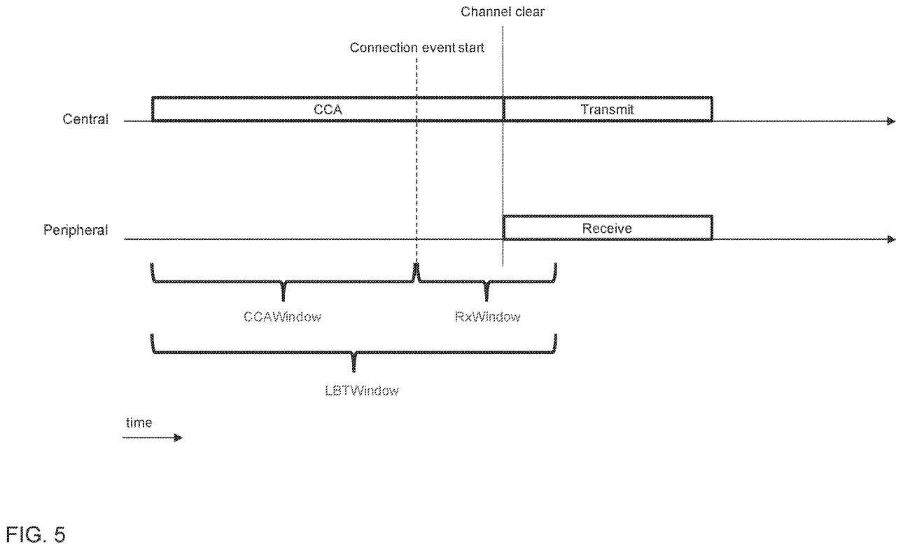

Once the channel is detected to be clear (e.g. once a nearby WiFi™ or other radio transmission ceases), the central device 102 starts transmitting a channel reservation (CR) signal. This can be any signal that nearby radio devices, including WiFi™ devices, will detect as being above a noise floor when performing an energy detection (ED)-based clear channel assessment. It may consist only of modulated data randomly generated by the central device 102, without any header preamble, so as to have a low autocorrelation to avoid being incorrectly detected as a wanted BLE data packet by any device of the first system 100. The central device 102 waits a random delay time (e.g. in the range 10-100 us) after first detecting the channel as clear before the start of the connection event. If the channel is still clear after that, the central device 102 then starts transmitting the CR signal. A random delay is similarly applied, before transmitting the first data packet, if the channel is first detected as clear only after the start of the connection event, as described in more detail below with reference to FIG. 5. This use of random delays can help avoid interference if multiple devices are performing CCAs on the same channel by preventing them from all starting to transmit signals (e.g. CR signals) simultaneously.

The central device 102 transmits the CR signal until the start of the connection event. In this way, it prevents nearby BLE and WiFi™ radio devices that also implement LBT from starting to transmit over the start of the connection event. When the connection event starts, the central device 102 starts transmitting the first data packet of the connection event to the relevant peripheral device 104-108. At the same time, or shortly beforehand (e.g. to account for any drift between the clock of the devices), the peripheral device 104-108 opens its receive window (RxWindow) to start receiving the data. If necessary, it will keep its receive circuitry active beyond the nominal end point of the RxWindow in order to receive the whole data packet.

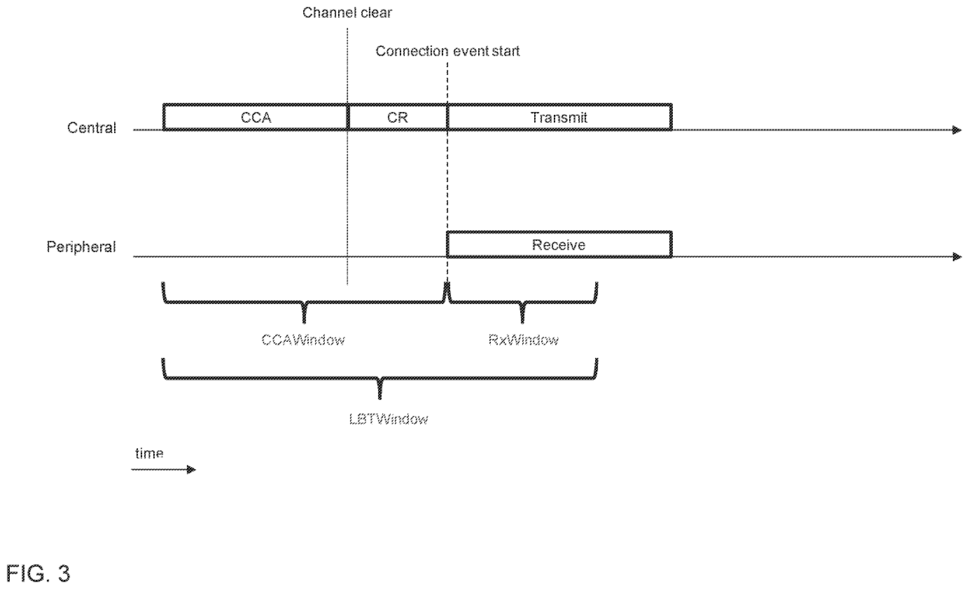

FIG. 3 illustrates an example of this in practice, showing how the central device 102 performs a CCA, which is followed by it transmitting a CR signal and then the first data packet, which is received by the peripheral device 104-108. The CCA window (CCAWindow) of the central device 102 and of the receive window (RxWindow) of the peripheral device 104-108 used in the example transmission are shown. In this example, the packet extends beyond the end of the RxWindow but the peripheral device continues receiving until the end.

The combined CCAWindow and RxWindow is referred to herein as the LBTWindow. It represents a total “channel access” window for the peripheral device, during which other the channel is always either reserved for communication with the peripheral device (i.e. while the CR signal is being transmitted) or available for communication with the peripheral device (i.e. while the peripheral's radio receiver is active).

The central device 102 and each peripheral device 104-108 can negotiate a respective duration for the receive window (RxWindow) of the peripheral 104-108. This enables the peripheral 104-108 to request a RxWindow that is compatible with its performance requirements, e.g. with regard to power consumption or bandwidth. The RxWindows may be longer than traditional BLE receive windows, which are 16 us. In particular, they may have a minimum duration, after the connection event starts, of 32 us, 64 us, 128 us, 1 ms or more, and may, at times, be negotiated to be larger still. When there is little interference, this will not adversely affect power consumption, since the first data packet will be received early within the receive window anyway. A longer RxWindow will increase power consumption under noisy channel conditions, e.g. as described with reference to FIG. 5 below, but will improve reliability, when used in combination with CCAs as described herein.

Upon establishing a connection, the central device 102 and peripheral device 104-108 agree a RxWindow, and also agree a quality-of-service (QoS) level for LBT purposes. The QoS level may an integer selected from a predetermined set of integers (e.g. 1, 2 or 3). The RxWindow and QoS level may be negotiated between respective radio stacks 210 and/or software applications 208 running on the two devices 200.

The central device 102 also manages the CCA window length depending on the detected channel conditions and the agreed QoS level, in accordance with a set of QoS rules. These rules could be predefined within the radio stack 210 or provided at a host layer, e.g. by a software application 208. The CCA window determines the maximum time for which the central device 102 might transmit the channel reservation signal (i.e. if the CCA immediately detects a clear channel), and so also affects how much the first system 100 can influence the performance of the WiFi™ system 120. By controlling the CCAWindow based on conditions and QoS requirements, the first system 100 can be a good neighbour by limiting its impact on other systems 120.

The first system 100 can have a predetermined minimum size for the CCA window (CCAWindow). Initially, each new connection may use this minimum size for CCAWindow. However, the agreed QoS level determines which of a predetermined set of rules for LBT is followed. These rules include a specification of channel conditions that trigger an increase in the CCAWindow size.

The peripheral devices 104-108 may maintain the same respective receive window (RxWindow) lengths over time, regardless of changing channel conditions, or they may be configured to increase their nominal receive windows (RxWindow) in response to detecting lost connection events—i.e. connection events at which no packet is received from the central device 102. Each peripheral device may increase its RxWindow, through negotiation with the central device 102, at least up to a maximum RxWindow size, in response to detecting more than a threshold proportion of connection events being lost, e.g. over a rolling time period.

The central device 102 may be configured to increase its CCAWindow in response to missing connection events due to CCA busy detections. It may increase its CCAWindow, at least up to a maximum CCAWindow size, in response to detecting less than a minimum level of channel access due to CCA busy events.

In some examples, this minimum level of channel access may be determined or influenced by the agreed QoS level, e.g. in accordance with the set of QoS rules. In some examples, the agreed QoS level determines or influences a maximum CCAWindow size, or a maximum LBTWindow size.

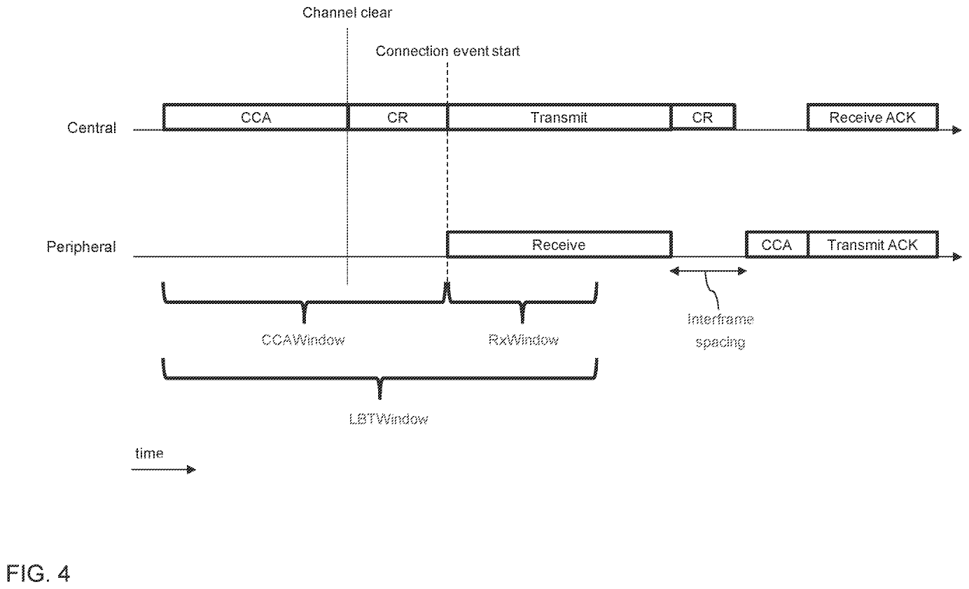

FIG. 4 illustrates a similar packet transmission to that of FIG. 3, but also shows an acknowledgement (ACK) packet being returned to the central device 102. The peripheral device 104-108 is configured to perform CCA before it transmits the ACK, and only to transmit the ACK if the channel is clear. While some embodiments may perform ongoing CCA checks during phase, the present embodiments perform only a single CCA check. If the channel is detected as busy, no ACK will be sent, and the central device 102 will have to assume the first packet was not received. Since the peripheral device 104-108 cannot send the ACK instantaneously after receiving the first packet, but must leave a predefined interframe spacing (and may also require some processing time to process the first packet), there is a risk of another device (e.g. a WiFi™ device 122-126) starting to transmit during this processing time, such that the ACK window is missed. Therefore, the central device 102 transmits a further channel reservation (CR) signal immediately after the end of the first packet, so as to reserve the channel during this interval. However, it ceases transmitting the CR signal before the interframe spacing duration (e.g. 150 μs) elapses, so as to avoid triggering the CCA of the peripheral 104-108. The peripheral 104-108 will perform its single CCA check once the interframe spacing has elapsed it finished receiving the first data packet, which should occur shortly after the first radio device stops transmitting its CR signal. Assuming the channel remains clear, the peripheral can then transmit the ACK packet.

Although FIG. 4 shows an acknowledgement being transmitted by the peripheral device 104-108, this is not required in all cases, and the mechanism described here for CCA and CR signals may also be applied for broadcasts (i.e. unidirectional connections where there is no ACK from the other device).

FIG. 5 illustrates a similar packet exchange to that of FIG. 3, but in a radio channel that remains busy (e.g. due to WiFi™ interference) beyond the start of a connection event. In this situation, the central device 102 does not transmit a channel reservation (CR) signal, but continues performing an ongoing CCA beyond the normal CCAWindow duration. Once the CCA detects the channel becoming clear, it waits for a random delay time (e.g. 10-100 us) then starts transmitting the first packet of the connection event, assuming the RxWindow is still open. If the RxWindow has closed, the connection event is missed. Setting a longer RxWindow, as described above, can thus be seen to provide improved reliability under noisy conditions.

The first system 100 may be configured to use LBT as described here whenever it is operating in a band that requires or recommends the use of LBT—e.g. the 6 GHZ band. It may disable LBT when operating in other bands—e.g. 2.4 GHz—although, in some embodiments, it may use LBT as disclosed herein when communicating in the 2.4 GHz band.

Some further features are implemented by the first system 100 to further improve reliability when using LBT.

First, the central device 102 includes a time stamp in its anchor point transmissions (i.e. in the first data packet of each connection event). A peripheral device 104-108 uses this timestamp to adjust for any delay, due to LBT, in the central's transmission of the first data packet, beyond the start time of the connection event, when synchronizing its clock to the anchor point. FIG. 5 provides an example of such a delay occurring.

Second, the adaptive frequency hopping (AFH) process can be modified to additionally take account of the number or frequency of CCA-busy events on a radio channel, in addition to lost packets, when determining if the radio channel should be used in the channel map or not. This can enable the first system 100 to better detect and avoid channels that are busy often.

Although these examples have been described in the context of radio devices 102-108 that support BLE, it will be appreciated that the same approach may be advantageously used in other current or future protocols, which may be standardised or proprietary.

It will be appreciated by those skilled in the art that the invention has been illustrated by describing one or more specific embodiments thereof, but is not limited to these embodiments; many variations and modifications are possible, within the scope of the accompanying claims.

1. A first radio device comprising hardware circuitry or comprising a processor and a memory storing software instructions for execution by the processor, wherein the first radio device is configured:
for each of a plurality of further radio devices, to determine a respective connection interval and a respective periodic series of connection events, having a period equal to the connection interval, each connection event of the periodic series of connection events comprising time for transmitting one or more data packets to the further radio device and optionally for receiving one or more data packets from the further radio device;
to communicate the respective connection interval to each of the further radio devices; and
before transmitting a first data packet of a connection event, over a radio channel, to a further radio device of the plurality of further radio devices, to perform a clear channel assessment to determine whether the radio channel is clear, and, in response to determining that the radio channel is clear before a start of the connection event, to transmit a channel reservation signal over the radio channel until the start of the connection event and then to transmit the first data packet over the radio channel to the further radio device.

2. The first radio device of claim 1, configured to transmit the channel reservation signal to signal to one or more other radio devices, each configured to perform clear channel assessments, that the radio channel is busy.

3. The first radio device of claim 1, configured to determine a respective receive window for each further radio device, and to communicate the determined receive window to the respective further radio device, wherein the determined receive window determines a maximum time that the respective further radio device will listen for a first data packet of a connection event without receiving the first data packet, and wherein each determined receive window has a duration of at least 32 us.

4. The first radio device of claim 1, configured to perform the clear channel assessment ongoingly until a sooner of i) determining that the radio channel is clear and ii) an end of a receive window for the further radio device, and not to transmit the channel reservation signal unless and until the radio channel is determined to be clear before the start of the connection event.

5. The first radio device of claim 1, configured, in response to determining that the radio channel is not clear before the start of the connection event, to transmit the first data packet over the radio channel to the further radio device in response to determining that the radio channel becomes clear after the start of the connection event and before an end of a receive window for the further radio device.

6. The first radio device of claim 1, configured to wait a random delay time after first detecting that the radio channel is clear before starting to transmit the channel reservation signal.

7. The first radio device of claim 1, configured, in response to determining that the radio channel is not clear before the start of the connection event, to determine whether a receive window for the further radio device remains open, and not to start transmitting the first data packet if the receive window has closed.

8. The first radio device of claim 1, wherein the channel reservation signal comprises or consists of modulated data, modulated according to a same modulation scheme as data of the first data packet.

9. The first radio device of claim 1, wherein the channel reservation signal comprises or consists of modulated pseudo-random data, generated by the first radio device.

10. The first radio device of claim 1, configured for Bluetooth Low Energy radio communication as a central device with the plurality of further radio devices as peripheral devices.

11. The first radio device of claim 1, wherein the clear channel assessment comprises determining whether a level of radio energy on the radio channel, or on a portion of spectrum that includes the radio channel, is above a noise-floor threshold.

12. The first radio device of claim 1, configured to include a time stamp in the first data packet of the connection event, indicative of a time of transmission of the first data packet, for the further radio device to use to synchronize a clock of the further radio device to compensate for any delay between the start of the connection event and a start of transmission of the first data packet.

13. The first radio device of claim 1, configured for each connection event of each periodic series of connection events, before transmitting a first data packet of the respective connection event, over a respective radio channel, to the respective further radio device, to perform a clear channel assessment to determine whether the radio channel is clear, and, in response to determining that the radio channel is clear, transmitting a channel reservation signal over the radio channel until a start of the connection event and then transmitting the respective first data packet over the radio channel to the further radio device.

14. The first radio device of claim 1, configured to transmit a second channel reservation signal, on the radio channel that the first data packet was transmitted on, after transmitting the first data packet.

15. The first radio device of claim 1, configured to negotiate a respective quality-of- service level with each further radio device, and to use the respective quality-of-service level for a further radio device to determine how long in advance of a connection event, for the further radio device, to start performing a clear channel assessment.

16. The first radio device of claim 1, configured to increase how long in advance of each connection event, for each further radio device, the first radio device starts performing a clear channel assessment in response to detecting a reduced level of channel access.

17. The first radio device of claim 1, configured to use an adaptive frequency hopping process to determine, for each connection event, a respective radio channel over which to transmit one or more data packets of the connection event, and further configured to exclude a radio channel from use at least partly in dependence on a result of one or more clear channel assessments performed by the first radio device for the radio channel.

18. A radio system comprising:
a first radio device; and
a plurality of further radio devices;
wherein the first radio device comprises hardware circuitry or comprises a processor and a memory storing software instructions for execution by the processor, and is configured:
for each of the plurality of further radio devices, to determine a respective connection interval and a respective periodic series of connection events, having a period equal to the connection interval, each connection event of the periodic series of connection events comprising time for transmitting one or more data packets to the further radio device and optionally for receiving one or more data packets from the further radio device;
to communicate the respective connection interval to each of the further radio devices; and
before transmitting a first data packet of a connection event, over a radio channel, to a further radio device of the plurality of further radio devices, to perform a clear channel assessment to determine whether the radio channel is clear, and, in response to determining that the radio channel is clear before a start of the connection event, to transmit a channel reservation signal over the radio channel until the start of the connection event and then to transmit the first data packet over the radio channel to the further radio device.

19. A method of radio communication performed by a first radio device, the method comprising:
for each of a plurality of further radio devices, determining a respective connection interval and a respective periodic series of connection events, having a period equal to the connection interval, each connection event of the periodic series of connection events comprising time for transmitting one or more data packets to the further radio device and optionally for receiving one or more data packets from the further radio device;
communicating the respective connection interval to each of the further radio devices; and
before transmitting a first data packet of a connection event, over a radio channel, to a further radio device of the plurality of further radio devices, performing a clear channel assessment to determine whether the radio channel is clear, and, in response to determining that the radio channel is clear before a start of the connection event, transmitting a channel reservation signal over the radio channel until the start of the connection event and then transmitting the first data packet over the radio channel to the further radio device.

20. A non-transitory computer-readable medium storing instructions which, when executed by a processor of a first radio device, cause the first radio device to perform the method of radio communication of claim 19.
